(19) United States
(12) Patent Application Publication
(10) Pub. No.: US 2026/0181039 A1
(43) Pub. Date: Jun. 25, 2026

(54) INFORMATION TRANSMISSION METHOD AND APPARATUS, TERMINAL, AND NETWORK SIDE DEVICE

(71) Applicant: VIVO MOBILE COMMUNICATION CO., LTD., Dongguan (CN)

(72) Inventors: Ang YANG, Dongguan (CN); Peng SUN, Dongguan (CN)

(73) Assignee: VIVO MOBILE COMMUNICATION CO., LTD., Dongguan, GD (CN)

(21) Appl. No.: 19/535,038

(22) Filed: Feb. 10, 2026

Related U.S. Application Data
(63) Continuation of application No. PCT/CN2024/109852, filed on Aug. 5, 2024.

(30) Foreign Application Priority Data
Aug. 11, 2023 (CN) 202311013660.9

(51) Int. Cl. H04L 67/10

(52) U.S. Cl. CPC H04L 67/10

(57) ABSTRACT

This application discloses an information transmission method and apparatus, a terminal, and a network side device, and belongs to the field of communication technologies. The information transmission method in embodiments of this application includes: obtaining, by a terminal, an artificial intelligence (AI) model and a first identifier associated with the AI model, where the first identifier is associated with data collection or a dataset; and sending, by the terminal, a target request to a network side device, where the target request includes the first identifier, and the target request is used for requesting to perform model identification of the AI model.

### CROSS-REFERENCE TO RELATED APPLICATIONS

This application is a continuation application of International Application No. PCT/CN2024/109852, filed on Aug. 5, 2024, which claims priority to Chinese Patent Application No. 202311013660.9, filed in China on Aug. 11, 2023, which is incorporated herein by reference in its entirety.

### TECHNICAL FIELD

This application belongs to the field of communication technologies, and specifically, to an information transmission method and apparatus, a terminal, and a network side device.

### BACKGROUND

Currently, there is no direct association relationship among dataset collection, artificial intelligence (AI) model registration, and an AI model identifier. A user equipment (UE) side needs to report a large amount of model description information to a network side device side, so that the network side device knows an applicable scope and an applicable scenario of a registration model.

### SUMMARY

According to a first aspect, an information transmission method is provided, including:
obtaining, by a terminal, an artificial intelligence (AI) model and a first identifier associated with the AI model, where the first identifier is associated with data collection or a dataset; and
sending, by the terminal, a target request to a network side device, where the target request includes the first identifier, and the target request is used for requesting to perform model identification of the AI model.

According to a second aspect, an information transmission method is provided, including:
receiving, by a network side device, a target request sent by a terminal, where the target request is used for requesting to perform model identification of an artificial intelligence (AI) model, the target request includes a first identifier, and the first identifier is associated with data collection or a dataset; and
performing, by the network side device in response to the target request, model identification of the AI model based on the first identifier.

According to a third aspect, an information transmission apparatus is provided, including:
an obtaining module, configured to obtain an artificial intelligence (AI) model and a first identifier associated with the AI model, where the first identifier is associated with data collection or a dataset; and
a first sending module, configured to send a target request to a network side device, where the target request includes the first identifier, and the target request is used for requesting to perform model identification of the AI model.

According to a fourth aspect, an information transmission apparatus is provided, including:
a first receiving module, configured to receive a target request sent by a terminal, where the target request is used for requesting to perform model identification of an artificial intelligence (AI) model, the target request includes a first identifier, and the first identifier is associated with data collection or a dataset; and
a model identification module, configured to perform, in response to the target request, model identification of the AI model based on the first identifier.

According to a fifth aspect, a terminal is provided. The terminal includes a processor and a memory. The memory stores a program or instructions executable on the processor. When the program or instructions are executed by the processor, steps of the method in the first aspect are implemented.

According to a sixth aspect, a terminal is provided, including a processor and a communication interface. The processor is configured to obtain an artificial intelligence (AI) model and a first identifier associated with the AI model, where the first identifier is associated with data collection or a dataset. The communication interface is configured to send a target request to a network side device, where the target request includes the first identifier, and the target request is used for requesting to perform model identification of the AI model.

According to a seventh aspect, a network side device is provided. The network side device includes a processor and a memory. The memory stores a program or instructions executable on the processor. When the program or instructions are executed by the processor, steps of the method in the first aspect are implemented.

According to an eighth aspect, a network side device is provided, including a processor and a communication interface. The communication interface is configured to receive a target request sent by a terminal, where the target request is used for requesting to perform model identification of an artificial intelligence (AI) model, the target request includes a first identifier, and the first identifier is associated with data collection or a dataset. The processor is configured to perform, in response to the target request, model identification of the AI model based on the first identifier.

According to a ninth aspect, a readable storage medium is provided. The readable storage medium stores a program or instructions. When the program or instructions are executed by a processor, steps of the method in the first aspect are implemented, or steps of the method in the second aspect are implemented.

According to a tenth aspect, a wireless communication system is provided, including a terminal and a network side device. The terminal may be configured to perform steps of the method in the first aspect. The network side device may be configured to perform steps of the method in the second aspect.

According to an eleventh aspect, a chip is provided. The chip includes a processor and a communication interface. The communication interface is coupled to the processor, and the processor is configured to run a program or instructions, to implement the method in the first aspect or implement the method in the second aspect.

According to a twelfth aspect, a computer program/program product is provided. The computer program/program product is stored in a storage medium, and the computer program/program product is executed by at least one processor to implement steps of the information transmission method in the first aspect or implement steps of the information transmission method in the second aspect.

### BRIEF DESCRIPTION OF THE DRAWINGS

FIG. 1 is a schematic diagram of a wireless communication system to which embodiments of this application are applicable;

FIG. 2 is a schematic diagram of a structure of a neural network according to a related technology;

FIG. 3 is a schematic diagram of a structure of a neuron according to a related technology;

FIG. 4 is a schematic flowchart 1 of an information transmission method according to an embodiment of this application;

FIG. 5 is a schematic flowchart 2 of an information transmission method according to an embodiment of this application;

FIG. 6 is a schematic diagram 1 of interaction between a terminal and a network side device according to an embodiment of this application;

FIG. 7 is a schematic diagram 2 of interaction between a terminal and a network side device according to an embodiment of this application;

FIG. 8 is a schematic diagram 3 of interaction between a terminal and a network side device according to an embodiment of this application;

FIG. 9 is a schematic diagram 1 of a structure of an information transmission apparatus according to an embodiment of this application;

FIG. 10 is a schematic diagram 2 of a structure of an information transmission apparatus according to an embodiment of this application;

FIG. 11 is a schematic diagram of a structure of a communication device according to an embodiment of this application;

FIG. 12 is a schematic diagram of a structure of a terminal according to an embodiment of this application; and

FIG. 13 is a schematic diagram of a structure of a network side device according to an embodiment of this application.

### DETAILED DESCRIPTION

The following clearly describes the technical solutions in embodiments of this application with reference to the accompanying drawings in the embodiments of this application. It is clear that the described embodiments are a part but not all of the embodiments of this application. All other embodiments obtained by a person of ordinary skill in the art based on the embodiments of this application shall fall within the protection scope of this application.

The terms “first”, “second”, and the like in this application are used to distinguish similar objects, but are not used to describe a specific sequence or order. It should be understood that terms used in this way are exchangeable in a proper case, so that the embodiments of this application can be implemented in an order other than that illustrated or described herein. In addition, objects distinguished by “first” and “second” are usually of one type, and a quantity of objects is not limited. For example, there may be one or more first objects. In addition, “or” in this application represents at least one of connected objects. For example, “A or B” covers three solutions, to be specific, a solution 1: including A and excluding B; a solution 2: including B and excluding A; and a solution 3: including both A and B. The character “/” usually indicates an “or” relationship between associated objects.

The term “indication” in this application may be a direct indication (or an explicit indication), or may be an indirect indication (or an implicit indication). The direct indication may be understood as that a sending party explicitly notifies a receiving party of content such as specific information, an operation that needs to be performed, or a request result in a sent indication. The indirect indication may be understood as that a receiving party determines corresponding information based on an indication sent by a sending party, or performs determining and determines, based on a determining result, an operation that needs to be performed or a request result.

It should be noted that the technologies described in the embodiments of this application are not limited to a long term evolution (LTE)/LTE-advanced (LTE-A) system, and may also be used in another wireless communication system, such as code division multiple access (CDMA), time division multiple access (TDMA), frequency division multiple access (FDMA), orthogonal frequency division multiple access (OFDMA), single-carrier frequency-division multiple access (SC-FDMA), or another system. The terms “system” and “network” in the embodiments of this application are usually interchangeably used. The described technologies are applicable to the systems and radio technologies mentioned above, and are also applicable to other systems and radio technologies. The following descriptions describe a new radio (NR) system for exemplary, and NR terms are used in most of the following descriptions. However, the technologies are also applicable to a system other than the NR system, for example, a 6th generation (6G) communication system.

The reporting of the large amount of model description information leads to an increase in signaling overheads of a communication system.

Embodiments of this application provide an information transmission method and apparatus, a terminal, and a network side device, so that a problem of an increase in signaling overheads of a communication system can be resolved.

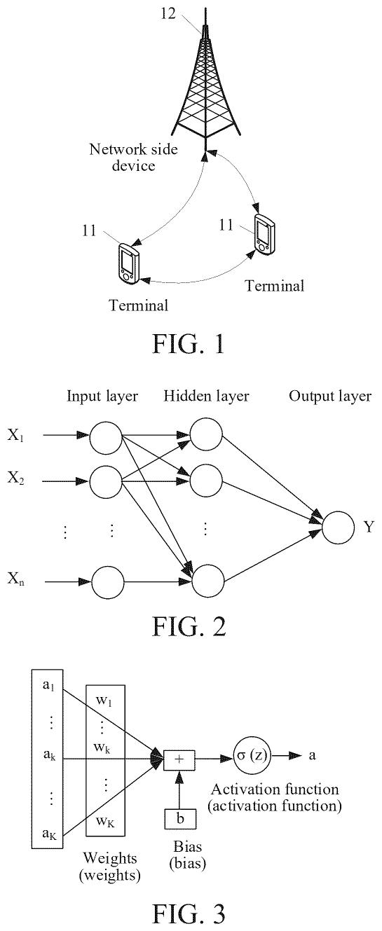

FIG. 1 is a block diagram of a wireless communication system to which embodiments of this application are applicable. The wireless communication system includes a terminal 11 and a network side device 12. The terminal 11 may be a terminal side device such as a mobile phone, a tablet computer (Tablet Personal Computer), a laptop computer, a notebook computer, a personal digital assistant (PDA), a palmtop computer, a netbook, an ultra-mobile personal computer (UMPC), a mobile internet device (MID), an augmented reality (AR), a virtual reality (VR) device, a robot, a wearable device, a flight vehicle, vehicle user equipment (VUE), a ship-mounted device, pedestrian user equipment (PUE), a smart household (a household device having a wireless communication function, such as a refrigerator, a television, a washing machine, or furniture), a game console, a personal computer (PC), a teller machine, or a self-service machine. The wearable device includes a smart watch, a smart band, a smart earphone, smart glasses, smart jewelry (a smart bracelet, a smart chain, a smart ring, a smart necklace, a smart anklet, a smart ankle chain, or the like), a smart wristband, smart clothing, or the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a Wireless Fidelity (Wi-Fi) node, or the like. The base station may be referred to as a NodeB (NB), an evolved NodeB (eNB), a next generation NodeB (gNB), a new radio NodeB (NR Node B), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another suitable term in the art, provided that a same technical effect is achieved. The base station is not limited to a specific technical word. It should be noted that, in this embodiment of this application, the base station in the NR system is merely used as an example for description, and a specific type of the base station is not limited.

The core network device may include, but is not limited to, at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), unified data repository (UDR), a home subscriber server (HSS), a centralized network configuration (CNC), a network repository function (NRF), a network exposure function (NEF), a local NEF (Local NEF, or L-NEF), a binding support function (BSF), an application function (AF), and the like. It should be noted that, in this embodiment of this application, the core network device in the NR system is merely used as an example for description, and a specific type of the core network device is not limited.

To ease of clearer understanding of the embodiments of this application, some related background technical knowledge is first described below.

### 1. Artificial Intelligence (AI)

The artificial intelligence (AI) has been widely applied to various fields currently. Integrating the artificial intelligence into a wireless communication network to significantly improve technical indicators, such as a throughput, a delay, and a user capacity, is an important task of a future wireless communication network. An AI module is implemented in a plurality of manners, for example, by using a neural network, a decision tree, a support vector machine, and a Bayes classifier.

FIG. 2 is a schematic diagram of a structure of a neural network according to a related technology. As shown in FIG. 2, the neural network includes an input layer, a hidden layer, and an output layer. X₁, X₂, . . . , and Xₙ represent n inputs, and Y represents an output. The neural network includes neurons. FIG. 3 is a schematic diagram of a structure of a neuron according to a related technology. As shown in FIG. 3, a₁, a₂, . . . , and a_{K} are inputs. K is a total quantity of inputs. w is a weight (multiplicative coefficient). b is a bias (additive coefficient). σ( ) is an activation function. a represents an output of the neuron. Common activation functions include a sigmoid function (Sigmoid), a hyperbolic tangent function (tanh), and a linear rectification function. The linear rectification function is also referred to as a rectified linear unit (ReLU).

The neuron is represented by using a formula (1).

$$z = {a}_{1} {w}_{1} + ... + {a}_{k} {w}_{k} + {a}_{K} {w}_{K} + b \qquad ( 1 )$$

a_{K} represents a kth input.

A parameter of the neural network is optimized by using a gradient optimization algorithm. The gradient optimization algorithm is an algorithm for minimizing or maximizing an objective function (which is also referred to as a loss function), and the objective function is usually a mathematical combination of a model parameter and data. For example, data X and a label Y corresponding to the data X are provided, and a neural network model f( ) is constructed. After the model is provided, a predicted output f(X) can be obtained based on an input X, and a difference (f(X)−Y) between a predicted value and a true value can be calculated. This is the loss function. An objective is to find proper w and b, so that a value of the foregoing loss function is minimized. A smaller loss value indicates that the model is closer to a true case.

Currently common optimization algorithms are basically based on an error back propagation (BP) algorithm. A basic idea of the BP algorithm is that a learning process includes two processes: forward propagation of a signal and back propagation of an error. During the forward propagation, an inputted sample is transmitted from the input layer, processed by the hidden layers layer by layer, and transmitted to the output layer. If an actual output of the output layer is inconsistent with an expected output, a back propagation phase of an error starts. The back propagation of the error is to transmit an outputted error in a form to the input layer through the hidden layers layer by layer, and allocate the error to all units of each layer, so as to obtain an error signal of the units of each layer. The error signal is used as a basis for rectifying a weight of each unit. This process of adjusting weights of layers during the forward propagation of the signal and the back propagation of the error is repeatedly performed. A process of continuously adjusting the weights is a learning and training process of the network. This process is performed until an error outputted by the network is reduced to an acceptable degree, or until learning is performed for a preset quantity of times.

The common optimization algorithms include gradient descent, stochastic gradient descent (SGD), mini-batch gradient descent, momentum, stochastic gradient descent with momentum (Nesterov), adaptive gradient descent (Adagrad), an adaptive learning rate (Adadelta), root mean square prop (RMSprop), adaptive moment estimation (Adam), and the like.

During back propagation of an error, in the optimization algorithms, a derivative or partial derivative of a current neuron is obtained based on an error or a loss obtained by using the loss function, an impact of a learning rate, a previous gradient, the derivative, the partial derivative, or the like is added to obtain a gradient, and the gradient is transmitted to a previous layer.

### 2. AI Unit or AI Model

The AI model may also be referred to as an AI unit, a machine learning (ML) model, an ML unit, an AI structure, an AI function, an AI feature, a neural network, a neural network function, a neural network function, or the like. Alternatively, the AI unit or the AI model may be a processing unit that can implement a specific algorithm, formula, processing procedure, capability, and the like related to AI. Alternatively, the AI unit or the AI model may be a processing method, algorithm, function, module, or unit for a particular dataset. Alternatively, the AI unit or the AI model may be a processing method, algorithm, function, module, or unit running on hardware related to AI or ML, such as a graphics processing unit (GPU), an embedded neural-network processing unit (NPU), a tensor processing unit (TPU), or an application-specific integrated circuit (ASIC). The particular dataset includes at least one of an input or an output of the AI unit or the AI model.

An identifier of the AI unit or the AI model may be an AI model identifier, an AI structure identifier, an AI algorithm identifier, an identifier of a particular dataset associated with the AI unit or the AI model, an identifier of a particular scenario, environment, channel feature, or device related to AI or ML, or an identifier of a function, feature, capability, or module related to AI or ML.

An information transmission method provided in the embodiments of this application is described in detail below by using some embodiments and application scenarios thereof with reference to the accompanying drawings.

The information transmission method provided in the embodiments of this application is applicable to a model identification scenario. A terminal obtains an AI model and a first identifier associated with the AI model. Because the first identifier is associated with data collection or a dataset, when the terminal requests a network side device to perform model identification of the AI model, the terminal needs to send only the first identifier to the network side device and does not need to report a large amount of model description information to the network side device, so that the network side device can perform model identification of the AI model based on the first identifier, thereby reducing signaling overheads of a communication system.

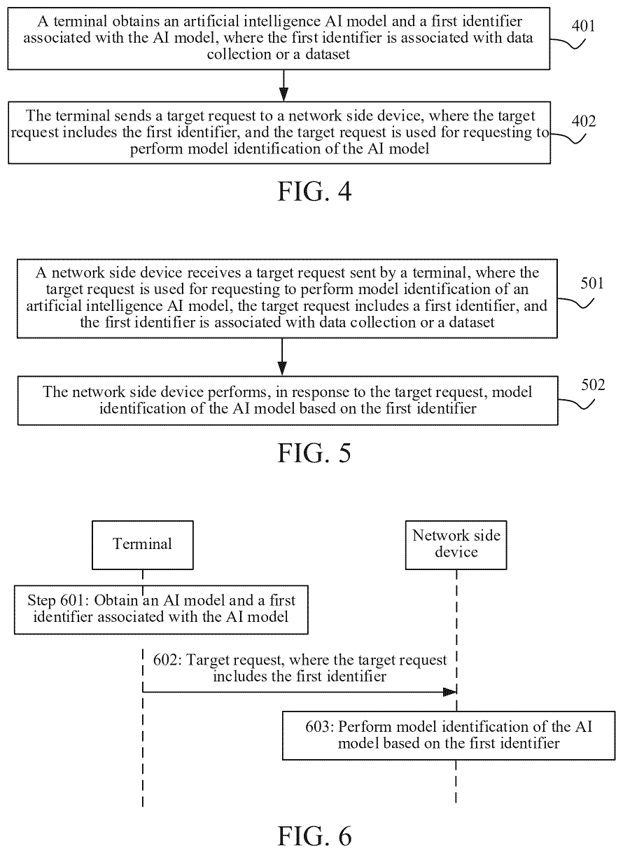

FIG. 4 is a schematic flowchart 1 of an information transmission method according to an embodiment of this application. As shown in FIG. 4, the method includes step 401 and step 402.

Step 401: A terminal obtains an artificial intelligence (AI) model and a first identifier associated with the AI model, where the first identifier is associated with data collection or a dataset.

It should be noted that this embodiment of this application is applicable to a model identification scenario. The terminal includes, but is not limited to, the types of the terminal 11 listed above. A network side device includes, but is not limited to, the types of the network side device 12 listed above. These are not limited in this embodiment of this application.

Specifically, the AI model may be trained by the terminal, the network side device, a network side server, a terminal server, a core network server, or a third-party server by using a dataset. The network side device triggers the data collection data collection, and the network side device may determine a resource configuration for the data collection. The resource configuration is associated with, indicates, or carries the first identifier. The resource configuration includes at least one of the following: measurement configuration (MeasConfig) information, such as a measurement object (MeasObject) or a channel state information-measurement configuration (Channel State Information-MeasConfig, CSI-MeasConfig); report configuration (ReportConfig) information, such as a channel state information-report configuration (CSI-ReportConfig); resource configuration information of a reference signal (RS) used for data collection, such as a CSI resource configuration (CSI-ResourceConfig), a demodulation reference signal-downlink configuration (Demodulation Reference Signal-DownlinkConfig, DMRS-DownlinkConfig), a CSI-synchronization signal block (SSB) resource, a CSI-interference measurement (IM)-Resource, a non-zero power (NZP)-CSI-RS-Resource, or a zero power (ZP)-CSI-RS-Resource; resource set configuration (ResourceSet Configuration) information of an RS used for data collection, such as a CSI-SSB-ResourceSet, a CSI-IM-ResourceSet, an NZP-CSI-RS-ResourceSet, or a ZP-CSI-RS-ResourceSet; master information block (MIB) information; or system information block (SIB) information. When configuring a resource for the data collection, the network side device configures one first identifier.

Optionally, when the terminal trains the AI model, the network side device collects a dataset based on the configured resource for the data collection, and sends the dataset to the terminal, to enable the terminal to train the AI model based on the dataset, so that the terminal obtains the AI model and the first identifier associated with the AI model, where the first identifier is associated with the data collection or the dataset. Alternatively, the network side device configures, to the terminal, the resource for the data collection, and the terminal collects a dataset based on the configured resource for the data collection, and trains the AI model by using the collected dataset, so that the terminal obtains the AI model and the first identifier associated with the AI model, where the first identifier is associated with the data collection or the dataset.

Optionally, when the network side device trains the AI model, the network side device collects a dataset based on the configured resource for the data collection, and trains the AI model by using the collected dataset, so that the network side device obtains the AI model and the first identifier associated with the AI model, where the first identifier is associated with the data collection or the dataset. Then, the network side device sends the AI model and the first identifier associated with the AI model to the terminal, so that the terminal obtains the AI model and the first identifier associated with the AI model, where the first identifier is associated with the data collection or the dataset.

Optionally, when the network side server, the terminal server, the core network server, or the third-party server trains the AI model, the network side device collects a dataset based on the configured resource for the data collection, and sends the dataset to the network side server, the terminal server, the core network server, or the third-party server. The network side server, the terminal server, the core network server, or the third-party server trains the AI model by using the dataset. In this case, the AI model corresponds to one first identifier, and the first identifier is associated with the data collection or the dataset. Then, the network side server, the terminal server, the core network server, or the third-party server sends the AI model to the terminal, so that the terminal obtains the AI model and the first identifier associated with the AI model, where the first identifier is associated with the data collection or the dataset. Alternatively, the network side device configures, to the network side server, the terminal server, the core network server, or the third-party server, the resource for the data collection. The network side server, the terminal server, the core network server, or the third-party server collects a dataset based on the configured resource for the data collection, and trains the AI model by using the collected dataset. In this case, the AI model corresponds to one first identifier, and the first identifier is associated with the data collection or the dataset. Then, the network side server, the terminal server, the core network server, or the third-party server sends the AI model to the terminal, so that the terminal obtains the AI model and the first identifier associated with the AI model, where the first identifier is associated with the data collection or the dataset. Alternatively, the network side device configures, to the terminal, the resource for the data collection. The terminal collects a dataset based on the configured resource for the data collection, and sends the dataset to the network side server, the terminal server, the core network server, or the third-party server. The network side server, the terminal server, the core network server, or the third-party server trains the AI model by using the dataset. In this case, the AI model corresponds to one first identifier, and the first identifier is associated with the data collection or the dataset. Then, the network side server, the terminal server, the core network server, or the third-party server sends the AI model to the terminal, so that the terminal obtains the AI model and the first identifier associated with the AI model, where the first identifier is associated with the data collection or the dataset.

After obtaining the AI model and the first identifier associated with the AI model, the terminal may perform model registration based on the first identifier, to obtain a model identifier (model ID). The model identifier includes a local model identifier (local model ID) or a global model identifier (global model ID), and the model identifier is associated with the first identifier. For example, the global model identifier is globally unique, and AI models of different structures, parameters, types, functions, manufacturers, distributors, and developers have different model identifiers. The local model identifier is not globally unique, and AI models of different structures, parameters, types, functions, manufacturers, distributors, and developers may have a same model identifier.

Optionally, the first identifier includes first information or coding information of the first information. The first information includes at least one of the following:
(1) information about a dataset or a dataset identifier (ID);
(2) dataset categorizing information or a dataset categorizing ID;
(3) information about additional conditions or an additional condition ID;
(4) information about applicable conditions or an applicable condition ID;
(5) information about applicable scenarios or an applicable scenario ID;
(6) information about internal conditions or an internal condition ID;
(7) cell information or a cell ID;
(8) area information or an area ID;
(9) scenario information or a scenario ID;
(10) hardware configuration information or a hardware configuration ID;
(11) antenna configuration information or an antenna configuration ID;
(12) radio resource configuration information or a radio resource configuration ID;
(13) wireless environment information or a wireless environment ID;
(14) wireless environment categorizing information or a wireless environment categorizing ID;
(15) radio access network (RAN) test configuration information or an RAN test configuration ID; or
(16) wireless test configuration information or a wireless test configuration ID.

Specifically, the dataset ID or dataset categorizing ID indicates wireless environment information such as a hardware configuration, an antenna configuration, a radio resource configuration, a wireless environment, a wireless environment characteristic, a RAN test configuration, a radio test configuration, cell information, area information, and scenario information, or indicates a dataset generated based on the wireless environment information. For example, the RAN test may refer to an RAN4 test.

For example, the dataset ID indicates some wireless environment information (or side conditions) or test configuration information used in the RAN test or the radio test configuration. The wireless environment information or the test configuration information includes a channel model (for example, a clustered delay line model (clustered Delay Line, CDL), a tapped delay line model (Tapped Delay Line, TDL), an urban macro base station (Urban Macro, UMa), a urban micro base station (Urban Micro, UMi), an indoor coverage scenario (Indoor), or a high-speed railway) and a channel configuration parameter (for example, a delay, a cell radius, a base station power, a user equipment (UE) power, a noise power, a UE moving speed, a base station antenna configuration, or a UE antenna configuration). The wireless environment information or the test configuration information is agreed in a protocol in advance, and there is no real wireless air interface data collection, but each manufacturer actively generates a related dataset by using a simulation platform or in another manner.

Step 402: The terminal sends a target request to the network side device, where the target request includes the first identifier, and the target request is used for requesting to perform model identification of the AI model.

Specifically, after obtaining the AI model and the first identifier associated with the AI model, the terminal may send the target request to the network side device. The target request includes the first identifier, and the target request is used to request the network side device to perform model identification model identification of the AI model. The model identification includes at least one of the following: model registration, model verification, model information reporting, and model information confirmation.

In the information transmission method provided in this embodiment of this application, the terminal obtains the AI model and the first identifier associated with the AI model. Because the first identifier is associated with the data collection or the dataset, when the terminal requests the network side device to perform model identification of the AI model, the terminal needs to send only the first identifier to the network side device and does not need to report a large amount of model description information to the network side device, so that the network side device can perform model identification of the AI model based on the first identifier, thereby reducing signaling overheads of a communication system.

Optionally, the first identifier is associated with the AI model or is associated with at least a part of model description information of the AI model.

Specifically, after training the AI model, a training party of the AI model obtains the at least a part of the model description information of the AI model. Therefore, the first identifier is associated with the AI model or is associated with the at least a part of the model description information of the AI model.

Optionally, the target request may further include the at least a part of the model description information of the AI model.

Specifically, the at least a part of the model description information of the AI model may be reported to the network side device together with the first identifier. To be specific, the terminal needs to report only the at least a part of the model description information of the AI model and does not need to report a large amount of model description information of the AI model, thereby reducing the signaling overheads of the communication system.

Optionally, the at least a part of the model description information of the AI model includes at least one of the following:
(a) function information (functionality) of the AI model;
(b) a feature or feature group to which the AI model is applicable;
(c) information about applicable scenarios of the AI model;
(d) information about applicability configurations of the AI model;
(e) input information of the AI model or a format of the input information;
(f) output information of the AI model or a format of the output information; or
(g) auxiliary information of the AI model, used for assisting the AI model to perform inference.

Optionally, the auxiliary information includes at least one of the following: the hardware configuration information; the antenna configuration information; the radio resource configuration information; or the wireless environment categorizing information.

Specifically, the auxiliary information may be displayed and directly used by the AI model, or may be converted into some identifiers or feature information to be implicitly used by the AI model.

Optionally, the method further includes at least one of the following:
1) The terminal performs life cycle management of the AI model based on the first identifier.

Specifically, after obtaining the AI model and the first identifier associated with the AI model, the terminal may directly perform life cycle management of the AI model based on the first identifier, thereby reducing complexity of the life cycle management of the AI model and improving flexibility of the communication system.

Optionally, a body of the life cycle management of the AI model may be at least one of the terminal and the network side device. For example, the terminal is the body of the life cycle management of the AI model, or the network side device is the body of the life cycle management of the AI model, or the terminal and the network side device together perform life cycle management of the AI model.

Optionally, the life cycle management of the AI model includes at least one of the following:
a) Activation or deactivation of the AI model;

Specifically, the activation or deactivation of the AI model may be performed based on an indication of the network side device, or actively determined by the terminal (where a result of the activation or deactivation of the AI model may be fed back to the network side device). Alternatively, the terminal actively performs evaluation and sends an evaluation result to the network side device, and the network side device performs final determining. For example, the terminal includes a plurality of AI models, the network side device indicates a first identifier of an AI model, and the terminal selects the AI model corresponding to the first identifier indicated by the network side device, and activates and uses the AI model. Alternatively, the terminal actively activates or deactivates an AI model, and the terminal feeds back a second identifier of the AI model to the network side device. Alternatively, the terminal determines, through evaluation, that an AI model needs to be activated or deactivated, the terminal feeds back a second identifier of the AI model to the network side device, and the network side device performs final determining.
b) Selection or switching of the AI model.

Specifically, the selection or switching of the AI model may be performed based on an indication of the network side device, or actively determined by the terminal (where a result of the selection or switching of the AI model may be fed back to the network side device). Alternatively, the terminal actively performs evaluation and sends an evaluation result to the network side device, and the network side device performs final determining. For example, the terminal includes a plurality of AI models, the network side device indicates the terminal to switch from a first identifier of a currently used AI model to a first identifier of an AI model, and the terminal may switch, based on the indication of the network side device, from the currently used AI model to the AI model indicated by the network side device. Alternatively, the terminal actively selects or switches an AI model, and the terminal feeds back a second identifier of the AI model to the network side device. Alternatively, the terminal determines, through evaluation, that an AI model needs to be selected or switched, the terminal feeds back a second identifier of the AI model to the network side device, and the network side device performs final determining.
c) Inference of the AI model.
d) Performance monitoring or performance management of the AI model.

Specifically, the terminal and the network side device may implement performance monitoring or performance management of the AI model together, or the terminal is independently responsible for the performance monitoring or performance management of the AI model, or the network side device is independently responsible for the performance monitoring or performance management of the AI model. For example, the terminal may monitor some performance indicators of the AI model, and the terminal sends the monitored performance indicators to the network side device, so that the network side device performs performance management on performance of the AI model. Alternatively, the terminal actively monitors some performance indicators of the AI model, so that the terminal performs performance management on the performance of the AI model. Alternatively, the network side device actively monitors some performance indicators of the AI model, so that the network side device performs performance management on the performance of the AI model.
e) Falling back to a non-AI model.

Specifically, in a process in which the terminal uses the AI model, the terminal may fall back a use state of the AI model to a use state of the non-AI model. Alternatively, the network side device indicates the terminal to fall back the use state of the AI model to the use state of the non-AI model. Alternatively, the terminal actively performs evaluation and sends an evaluation result to the network side device, and the network side device finally determines whether to fall back the use state of the AI model to the use state of the non-AI model.
f) Training or updating of the AI model.

Specifically, in the process in which the terminal uses the AI model, the terminal may train or update the AI model, to obtain a new AI model. Alternatively, the network side device trains or updates the AI model, to obtain a new AI model. Alternatively, the network side server, the terminal server, the core network server, or the third-party server trains or updates the AI model, and then sends an updated model to the terminal or the network side device.
g) Registration of the AI model.

Specifically, when obtaining the AI model, the terminal may register the AI model, or the network side device registers the AI model.
h) Configuration of the AI model.

Specifically, when obtaining the AI model, the terminal may configure the AI model, or the network side device configures the AI model.
i) Identification of the AI model.

Specifically, when obtaining the AI model, the terminal may initiate, to the network side device, identification on the AI model. Alternatively, when obtaining the AI model, the network side device may initiate, to the terminal, identification on the AI model.
2) The terminal receives a second identifier sent by the network side device, where the second identifier is used for identifying the AI model; and the second identifier is associated with the first identifier; and the terminal performs life cycle management of the AI model based on the second identifier.

Specifically, after the terminal sends the target request to the network side, because the target request may include the first identifier and the at least a part of the model description information of the AI model, the network side device may determine the second identifier for the AI model based on the first identifier and the at least a part of the model description information of the AI model that are reported by the terminal. The second identifier is used for identifying the AI model, and the second identifier is associated with the first identifier. The network side device then sends the second identifier to the terminal, and the terminal receives the second identifier sent by the network side device. After receiving the second identifier, the terminal may perform life cycle management of the AI model based on the second identifier, thereby reducing the complexity of the life cycle management of the AI model and improving the flexibility of the communication system.

Optionally, a body of the life cycle management of the AI model may be at least one of the terminal and the network side device. For example, the terminal is the body of the life cycle management of the AI model, or the network side device is the body of the life cycle management of the AI model, or the terminal and the network side device together perform life cycle management of the AI model.

FIG. 5 is a schematic flowchart 2 of an information transmission method according to an embodiment of this application. As shown in FIG. 5, the method includes step 501 and step 502.

Step 501: A network side device receives a target request sent by a terminal, where the target request is used for requesting to perform model identification of an artificial intelligence (AI) model, the target request includes a first identifier, and the first identifier is associated with data collection or a dataset.

Specifically, training of the AI model may be trained by the terminal, the network side device, a network side server, a terminal server, a core network server, or a third-party server by using a dataset. The network side device may trigger the data collection data collection.

Optionally, after triggering the data collection, the network side device may determine a resource configuration for the data collection. The resource configuration is associated with, indicates, or carries the first identifier. The resource configuration includes at least one of the following: measurement configuration (MeasConfig) information, such as a measurement object (MeasObject) or a channel state information-measurement configuration (Channel State Information-MeasConfig, CSI-MeasConfig); report configuration (ReportConfig) information, such as a channel state information-report configuration (CSI-ReportConfig); resource configuration information of a reference signal (RS) used for data collection, such as a CSI resource configuration (CSI-ResourceConfig), a demodulation reference signal-downlink configuration (Demodulation Reference Signal-DownlinkConfig, DMRS-DownlinkConfig), a CSI-synchronization signal block (SSB) resource, a CSI-interference measurement (IM)-Resource, a non-zero power (NZP)-CSI-RS-Resource, or a zero power (ZP)-CSI-RS-Resource; resource set configuration (ResourceSet Configuration) information of an RS used for data collection, such as a CSI-SSB-ResourceSet, a CSI-IM-ResourceSet, an NZP-CSI-RS-ResourceSet, or a ZP-CSI-RS-ResourceSet; master information block (MIB) information; or system information block (SIB) information. After determining the resource configuration for the data collection, when configuring a resource for the data collection, the network side device configures one first identifier.

Optionally, when the terminal trains the AI model, the network side device collects a dataset based on the configured resource for the data collection, and sends the dataset to the terminal, to enable the terminal to train the AI model based on the dataset, so that the terminal obtains the AI model and the first identifier associated with the AI model, where the first identifier is associated with the data collection or the dataset. Alternatively, the network side device configures, to the terminal, the resource for the data collection, and the terminal collects a dataset based on the configured resource for the data collection, and trains the AI model by using the collected dataset, so that the terminal obtains the AI model and the first identifier associated with the AI model, where the first identifier is associated with the data collection or the dataset.

Optionally, when the network side device trains the AI model, the network side device collects a dataset based on the configured resource for the data collection, and trains the AI model by using the collected dataset, so that the network side device obtains the AI model and the first identifier associated with the AI model, where the first identifier is associated with the data collection or the dataset. Then, the network side device sends the AI model and the first identifier associated with the AI model to the terminal, so that the terminal obtains the AI model and the first identifier associated with the AI model, where the first identifier is associated with the data collection or the dataset.

Optionally, when the network side server, the terminal server, the core network server, or the third-party server trains the AI model, the network side device collects a dataset based on the configured resource for the data collection, and sends the dataset to the network side server, the terminal server, the core network server, or the third-party server. The network side server, the terminal server, the core network server, or the third-party server trains the AI model by using the dataset. In this case, the AI model corresponds to one first identifier, and the first identifier is associated with the data collection or the dataset. Then, the network side server, the terminal server, the core network server, or the third-party server sends the AI model to the terminal, so that the terminal obtains the AI model and the first identifier associated with the AI model, where the first identifier is associated with the data collection or the dataset. Alternatively, the network side device configures, to the network side server, the terminal server, the core network server, or the third-party server, the resource for the data collection. The network side server, the terminal server, the core network server, or the third-party server collects a dataset based on the configured resource for the data collection, and trains the AI model by using the collected dataset. In this case, the AI model corresponds to one first identifier, and the first identifier is associated with the data collection or the dataset. Then, the third-party server sends the AI model to the terminal, so that the terminal obtains the AI model and the first identifier associated with the AI model, where the first identifier is associated with the data collection or the dataset. Alternatively, the network side device configures, to the terminal, the resource for the data collection. The terminal collects a dataset based on the configured resource for the data collection, and sends the dataset to the network side server, the terminal server, the core network server, or the third-party server. The network side server, the terminal server, the core network server, or the third-party server trains the AI model by using the dataset. In this case, the AI model corresponds to one first identifier, and the first identifier is associated with the data collection or the dataset. Then, the network side server, the terminal server, the core network server, or the third-party server sends the AI model to the terminal, so that the terminal obtains the AI model and the first identifier associated with the AI model, where the first identifier is associated with the data collection or the dataset.

After obtaining the AI model and the first identifier associated with the AI model, the terminal may perform model registration based on the first identifier, to obtain a model identifier (model ID). The model identifier includes a local model identifier (local model ID) or a global model identifier (global model ID), and the model identifier is associated with the first identifier. For example, the global model identifier is globally unique, and AI models of different structures, parameters, types, functions, manufacturers, distributors, and developers have different model identifiers. The local model identifier is not globally unique, and AI models of different structures, parameters, types, functions, manufacturers, distributors, and developers may have a same model identifier.

In practice, the terminal may send the target request to the network side device, and the network side device receives the target request sent by the terminal. The target request is used for requesting to perform model identification of the AI model, the target request includes the first identifier, and the first identifier is associated with the data collection or the dataset.

Optionally, the first identifier includes first information or coding information of the first information. The first information includes at least one of the following:
(1) information about a dataset or a dataset identifier (ID);
(2) dataset categorizing information or a dataset categorizing ID;
(3) information about additional conditions or an additional condition ID;
(4) information about applicable conditions or an applicable condition ID;
(5) information about applicable scenarios or an applicable scenario ID;
(6) information about internal conditions or an internal condition ID;
(7) cell information or a cell ID;
(8) area information or an area ID;
(9) scenario information or a scenario ID;
(10) hardware configuration information or a hardware configuration ID;
(11) antenna configuration information or an antenna configuration ID;
(12) radio resource configuration information or a radio resource configuration

ID;
(13) wireless environment information or a wireless environment ID;
(14) wireless environment categorizing information or a wireless environment categorizing ID;
(15) radio access network (RAN) test configuration information or an RAN test configuration ID; or
(16) wireless test configuration information or a wireless test configuration ID.

Specifically, the dataset ID or dataset categorizing ID indicates wireless environment information such as a hardware configuration, an antenna configuration, a radio resource configuration, a wireless environment, a wireless environment characteristic, a RAN test configuration, a radio test configuration, cell information, area information, and scenario information, or indicates a dataset generated based on the wireless environment information. For example, the RAN test refers to an RAN4 test.

For example, the dataset ID indicates some wireless environment information (or side conditions) or test configuration information used in the RAN test or the radio test configuration. The wireless environment information or the test configuration information includes a channel model (for example, a clustered delay line model (clustered Delay Line, CDL), a tapped delay line model (Tapped Delay Line, TDL), an urban macro base station (Urban Macro, UMa), a urban micro base station (Urban Micro, UMi), an indoor coverage scenario (Indoor), or a high-speed railway) and a channel configuration parameter (for example, a delay, a cell radius, a base station power, a user equipment (User Equipment, UE) power, a noise power, a UE moving speed, a base station antenna configuration, or a UE antenna configuration). The wireless environment information or the test configuration information is agreed in a protocol in advance, and there is no real wireless air interface data collection, but each manufacturer actively generates a related dataset by using a simulation platform or in another manner.

Step 502: The network side device performs, in response to the target request, model identification of the AI model based on the first identifier.

Specifically, after receiving the target request sent by the terminal, the network side device responds to the target request. Because the target request includes the first identifier, the network side device may perform model identification model identification of the AI model based on the first identifier. The model identification includes at least one of the following: model registration, model verification, model information reporting, and model information confirmation.

In the information transmission method provided in this embodiment of this application, the network side device receives the target request sent by the terminal. The target request is used for requesting to perform model identification of the artificial intelligence (AI) model. Because the target request includes the first identifier, and the first identifier is associated with the data collection or the dataset, the network side device needs to obtain only the first identifier sent by the terminal and does not need to obtain a large amount of model description information to perform model identification of the AI model based on the first identifier, thereby reducing signaling overheads of a communication system.

Optionally, the first identifier is associated with the AI model or is associated with at least a part of model description information of the AI model.

Specifically, after training the AI model, a training party of the AI model obtains the at least a part of the model description information of the AI model. Therefore, the first identifier is associated with the AI model or is associated with the at least a part of the model description information of the AI model.

Optionally, the target request further includes the at least a part of the model description information of the AI model.

Specifically, the at least a part of the model description information of the AI model may be reported to the network side device together with the first identifier. To be specific, the terminal needs to report only the at least a part of the model description information of the AI model and does not need to report a large amount of model description information of the AI model, thereby reducing the signaling overheads of the communication system.

Optionally, the at least a part of the model description information of the AI model includes at least one of the following:
(a) function information (functionality) of the AI model;
(b) a feature or feature group to which the AI model is applicable;
(c) information about applicable scenarios of the AI model;
(d) information about applicability configurations of the AI model;
(e) input information of the AI model or a format of the input information;
(f) output information of the AI model or a format of the output information; or
(g) auxiliary information of the AI model, used for assisting the AI model to perform inference.

Optionally, the auxiliary information includes at least one of the following: the hardware configuration information; the antenna configuration information; the radio resource configuration information; or the wireless environment categorizing information.

Specifically, the auxiliary information may be displayed and directly used by the AI model, or may be converted into some identifiers or feature information to be implicitly used by the AI model.

Optionally, the method further includes at least one of the following:
1) The network side device performs life cycle management of the AI model based on the first identifier.

Specifically, after obtaining the first identifier, the network side device may directly perform life cycle management of the AI model based on the first identifier, thereby reducing complexity of the life cycle management of the AI model and improving flexibility of the communication system.

Optionally, a body of the life cycle management of the AI model may be at least one of the terminal and the network side device. For example, the terminal is the body of the life cycle management of the AI model, or the network side device is the body of the life cycle management of the AI model, or the terminal and the network side device together perform life cycle management of the AI model.

Optionally, the life cycle management of the AI model includes at least one of the following:
a) Activation or deactivation of the AI model;

Specifically, the activation or deactivation of the AI model may be performed based on an indication of the network side device, or actively determined by the terminal (where a result of the activation or deactivation of the AI model may be fed back to the network side device). Alternatively, the terminal actively performs evaluation and sends an evaluation result to the network side device, and the network side device performs final determining. For example, the terminal includes a plurality of AI models, the network side device indicates a first identifier of an AI model, and the terminal selects the AI model corresponding to the first identifier indicated by the network side device, and activates and uses the AI model. Alternatively, the terminal actively activates or deactivates an AI model, and the terminal feeds back a second identifier of the AI model to the network side device. Alternatively, the terminal determines, through evaluation, that an AI model needs to be activated or deactivated, the terminal feeds back a second identifier of the AI model to the network side device, and the network side device performs final determining.
b) Selection or switching of the AI model.

Specifically, the selection or switching of the AI model may be performed based on an indication of the network side device, or actively determined by the terminal (where a result of the selection or switching of the AI model may be fed back to the network side device). Alternatively, the terminal actively performs evaluation and sends an evaluation result to the network side device, and the network side device performs final determining. For example, the terminal includes a plurality of AI models, the network side device indicates the terminal to switch from a first identifier of a currently used AI model to a first identifier of an AI model, and the terminal may switch, based on the indication of the network side device, from the currently used AI model to the AI model indicated by the network side device. Alternatively, the terminal actively selects or switches an AI model, and the terminal feeds back a second identifier of the AI model to the network side device. Alternatively, the terminal determines, through evaluation, that an AI model needs to be selected or switched, the terminal feeds back a second identifier of the AI model to the network side device, and the network side device performs final determining.
c) Inference of the AI model.
d) Performance monitoring or performance management of the AI model.

Specifically, the terminal and the network side device may implement performance monitoring or performance management of the AI model together, or the terminal is independently responsible for the performance monitoring or performance management of the AI model, or the network side device is independently responsible for the performance monitoring or performance management of the AI model. For example, the terminal may monitor some performance indicators of the AI model, and the terminal sends the monitored performance indicators to the network side device, so that the network side device performs performance management on performance of the AI model. Alternatively, the terminal actively monitors some performance indicators of the AI model, so that the terminal performs performance management on the performance of the AI model. Alternatively, the network side device actively monitors some performance indicators of the AI model, so that the network side device performs performance management on the performance of the AI model.
e) Falling back to a non-AI model.

Specifically, in a process in which the terminal uses the AI model, the terminal may fall back a use state of the AI model to a use state of the non-AI model. Alternatively, the network side device indicates the terminal to fall back the use state of the AI model to the use state of the non-AI model. Alternatively, the terminal actively performs evaluation and sends an evaluation result to the network side device, and the network side device finally determines whether to fall back the use state of the AI model to the use state of the non-AI model.
f) Training or updating of the AI model.

Specifically, in the process in which the terminal uses the AI model, the terminal may train or update the AI model, to obtain a new AI model. Alternatively, the network side device trains or updates the AI model, to obtain a new AI model. Alternatively, the network side server, the terminal server, the core network server, or the third-party server trains or updates the AI model, and then sends an updated model to the terminal or the network side device.
g) Registration of the AI model.

Specifically, when obtaining the AI model, the terminal may register the AI model, or the network side device registers the AI model.
h) Configuration of the AI model.

Specifically, when obtaining the AI model, the terminal may configure the AI model, or the network side device configures the AI model.
i) Identification of the AI model.

Specifically, when obtaining the AI model, the terminal may initiate, to the network side device, identification on the AI model. Alternatively, when obtaining the AI model, the network side device may initiate, to the terminal, identification on the AI model.
2) The network side device determines a second identifier for the AI model based on the first identifier and the at least a part of the model description information of the AI model, where the second identifier is used for identifying the AI model; and the second identifier is associated with the first identifier; and the network side device performs life cycle management of the AI model based on the second identifier.

Specifically, the network side device may determine the second identifier for the AI model based on the first identifier and the at least a part of the model description information of the AI model. The second identifier is used for identifying the AI model, and the second identifier is associated with the first identifier. After determining the second identifier for the AI model, the network side device may perform life cycle management of the AI model based on the second identifier, thereby reducing the complexity of the life cycle management of the AI model and improving the flexibility of the communication system.

Optionally, a body of the life cycle management of the AI model may be at least one of the terminal and the network side device. For example, the terminal is the body of the life cycle management of the AI model, or the network side device is the body of the life cycle management of the AI model, or the terminal and the network side device together perform life cycle management of the AI model.

Optionally, at least a part of bits, fields, or content in the second identifier includes the first identifier or a part of content of the first identifier, or is associated with the first identifier or the part of the content of the first identifier.

For example, the second identifier has 100 bits (bit). 10 bits, a field, or some content is the first identifier or a part of content of the first identifier. Alternatively, the 10 bits, the field, or the content is associated with the first identifier or the part of the content of the first identifier. Alternatively, the 10 bits, the field, or the content indicates some information that includes the first identifier or the part of the content of the first identifier. Alternatively, the 10 bits, the field, or the content is coding information of the first identifier or the part of the content of the first identifier.

Optionally, the second identifier includes second information and third information. The second information is identifier information allocated by the network side device to the AI model when the network side device performs model identification. The third information includes any one of the following: the first identifier; a part of content of the first identifier; the coding information of the first identifier; coding information of the part of the content of the first identifier; association information of the first identifier; or association information of the part of the content of the first identifier.

Specifically, the second information is the identifier information allocated by the network side device to the AI model when the network side device performs model identification, to be specific, the identifier information allocated to the AI model when the network side device performs model identification of the AI model based on the first identifier after the network side device obtains the first identifier. The allocated identifier information is not associated with the first identifier. The third information includes any one of the following: the first identifier; the part of the content of the first identifier; the coding information of the first identifier; the coding information of the part of the content of the first identifier; the association information of the first identifier; or the association information of the part of the content of the first identifier. When the network side device performs life cycle management of the AI model, the second identifier including the second information and the third information is used to perform life cycle management of the AI model, thereby improving management efficiency of the AI model.

Optionally, the second identifier includes not only the second information and the third information, that is, the second identifier may further include other information in addition to the second information and the third information.

Optionally, the network side device sends the second identifier to the terminal.

Specifically, after determining the second identifier of the AI model, the network side device may send the second identifier to the terminal, so that the terminal performs life cycle management of the AI model based on the second identifier, thereby reducing the complexity of the life cycle management of the AI model and improving the flexibility of the communication system.

Optionally, the terminal and the network side device may perform life cycle management of the AI model together. For example, after training the AI model, the terminal may send the AI model and the first identifier to the network side device. The network side device trains the AI model, and sends the AI model to the terminal after the training. Alternatively, after training the AI model, the third-party server simultaneously sends the AI model and the first identifier to the terminal and the network side device, so that the terminal and the network side device perform life cycle management of the AI model together.

FIG. 6 is a schematic diagram 1 of interaction between a terminal and a network side device according to an embodiment of this application. As shown in FIG. 6, step 601 to step 603 are included.

Step 601: A terminal obtains an AI model and a first identifier associated with the AI model, where the first identifier is associated with data collection or a dataset.

Step 602: The terminal sends a target request to a network side device, where the target request includes the first identifier, and the target request is used for requesting to perform model identification of the AI model.

Step 603: The network side device performs, in response to the target request, model identification of the AI model based on the first identifier.

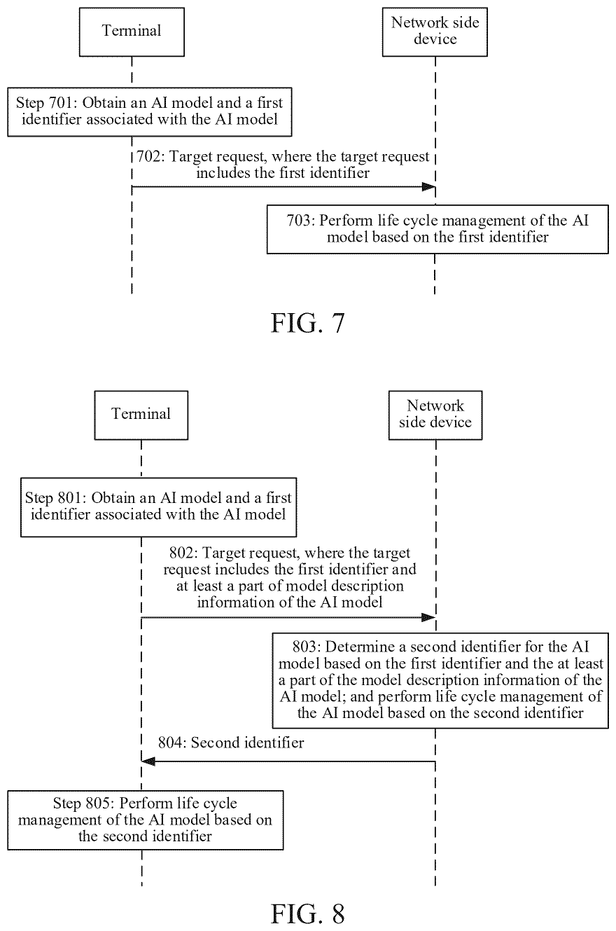

FIG. 7 is a schematic diagram 2 of interaction between a terminal and a network side device according to an embodiment of this application. As shown in FIG. 7, step 701 to step 703 are included.

Step 701: A terminal obtains an AI model and a first identifier associated with the AI model, where the first identifier is associated with data collection or a dataset.

Step 702: The terminal sends a target request to a network side device, where the target request includes the first identifier.

Step 703: The network side device performs, in response to the target request, life cycle management of the AI model based on the first identifier.

FIG. 8 is a schematic diagram 3 of interaction between a terminal and a network side device according to an embodiment of this application. As shown in FIG. 8, step 801 to step 805 are included.

Step 801: A terminal obtains an AI model and a first identifier associated with the AI model, where the first identifier is associated with data collection or a dataset.

Step 802: The terminal sends a target request to a network side device, where the target request includes the first identifier and at least a part of model description information of the AI model.

Step 803: The network side device determines a second identifier for the AI model based on the first identifier and the at least a part of the model description information of the AI model, where the second identifier is used for identifying the AI model; and the second identifier is associated with the first identifier; and the network side device performs life cycle management of the AI model based on the second identifier.

Step 804: The network side device sends the second identifier to the terminal.

Step 805: The terminal receives the second identifier sent by the network side device; and performs life cycle management of the AI model based on the second identifier.

The information transmission method provided in the embodiments of this application may be executed by an information transmission apparatus. In the embodiments of this application, an information transmission apparatus provided in the embodiments of this application is described by using an example in which the information transmission apparatus performs the information transmission method.

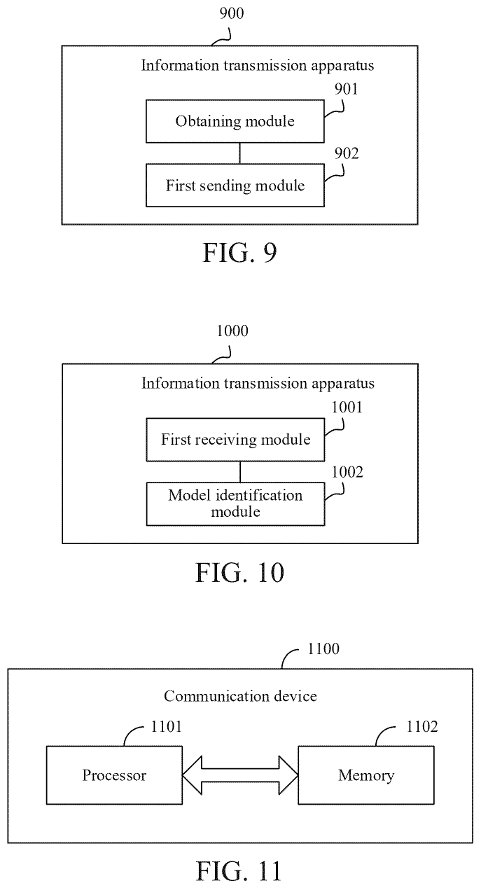

FIG. 9 is a schematic diagram 1 of a structure of an information transmission apparatus according to an embodiment of this application. As shown in FIG. 9, the information transmission apparatus 900 includes an obtaining module 901 and a first sending module 902.

The obtaining module 901 is configured to obtain an artificial intelligence (AI) model and a first identifier associated with the AI model, where the first identifier is associated with data collection or a dataset.

The first sending module 902 is configured to send a target request to a network side device, where the target request includes the first identifier, and the target request is used for requesting to perform model identification of the AI model.

In the information transmission apparatus provided in this embodiment of this application, the AI model and the first identifier associated with the AI model are obtained. Because the first identifier is associated with the data collection or the dataset, when the network side device is requested to perform model identification of the AI model, only the first identifier needs to be sent to the network side device and a large amount of model description information does not need to be reported to the network side device, so that the network side device can perform model identification of the AI model based on the first identifier, thereby reducing signaling overheads of a communication system.

Optionally, the first identifier includes first information or coding information of the first information. The first information includes at least one of the following:
information about a dataset or a dataset identifier (ID);
dataset categorizing information or a dataset categorizing ID;
information about additional conditions or an additional condition ID;
information about applicable conditions or an applicable condition ID;
information about applicable scenarios or an applicable scenario ID;
information about internal conditions or an internal condition ID;
cell information or a cell ID;
area information or an area ID;
scenario information or a scenario ID;
hardware configuration information or a hardware configuration ID;
antenna configuration information or an antenna configuration ID;
radio resource configuration information or a radio resource configuration ID;
wireless environment information or a wireless environment ID;
wireless environment categorizing information or a wireless environment categorizing ID;
radio access network (RAN) test configuration information or an RAN test configuration ID; or
wireless test configuration information or a wireless test configuration ID.

Optionally, the target request further includes the at least a part of the model description information of the AI model.

Optionally, the first identifier is associated with the AI model or is associated with at least a part of model description information of the AI model.

Optionally, the at least a part of the model description information of the AI model includes at least one of the following:
function information of the AI model;
a feature or feature group to which the AI model is applicable;
information about applicable scenarios of the AI model;
information about applicability configurations of the AI model;
input information of the AI model or a format of the input information;
output information of the AI model or a format of the output information; or
auxiliary information of the AI model, used for assisting the AI model to perform inference.

Optionally, the auxiliary information includes at least one of the following: the hardware configuration information; the antenna configuration information; the radio resource configuration information; or the wireless environment categorizing information.

Optionally, the information transmission apparatus 900 further includes at least one of the following:
a first life cycle management module, configured to perform life cycle management of the AI model based on the first identifier; or
a second receiving module, configured to receive a second identifier sent by the network side device, where the second identifier is used for identifying the AI model; and the second identifier is associated with the first identifier; and perform life cycle management of the AI model based on the second identifier.

Optionally, the life cycle management of the AI model includes at least one of the following:
activation or deactivation of the AI model;
selection or switching of the AI model;
inference of the AI model;
performance monitoring or performance management of the AI model;
falling back to a non-AI model;
training or updating of the AI model;
registration of the AI model;
configuration of the AI model; or
identification of the AI model.

FIG. 10 is a schematic diagram 2 of a structure of an information transmission apparatus according to an embodiment of this application. As shown in FIG. 10, the information transmission apparatus 1000 includes a first receiving module 1001 and a model identification module 1002.

The first receiving module 1001 is configured to receive a target request sent by a terminal, where the target request is used for requesting to perform model identification of an artificial intelligence (AI) model, the target request includes a first identifier, and the first identifier is associated with data collection or a dataset.

The model identification module 1002 is configured to perform, in response to the target request, model identification of the AI model based on the first identifier.

In the information transmission apparatus provided in this embodiment of this application, the target request sent by the terminal is received. The target request is used for requesting to perform model identification of the artificial intelligence (AI) model. Because the target request includes the first identifier, and the first identifier is associated with the data collection or the dataset, only the first identifier sent by the terminal needs to be obtained and a large amount of model description information does not need to be obtained to perform model identification of the AI model based on the first identifier, thereby reducing signaling overheads of a communication system.

Optionally, the first identifier includes first information or coding information of the first information. The first information includes at least one of the following:
information about a dataset or a dataset identifier (ID);
dataset categorizing information or a dataset categorizing ID;
information about additional conditions or an additional condition ID;
information about applicable conditions or an applicable condition ID;
information about applicable scenarios or an applicable scenario ID;
information about internal conditions or an internal condition ID;
cell information or a cell ID;
area information or an area ID;
scenario information or a scenario ID;
hardware configuration information or a hardware configuration ID;
antenna configuration information or an antenna configuration ID;
radio resource configuration information or a radio resource configuration ID;
wireless environment information or a wireless environment ID;
wireless environment categorizing information or a wireless environment categorizing ID;
radio access network (RAN) test configuration information or an RAN test configuration ID; or
wireless test configuration information or a wireless test configuration ID.

Optionally, the target request further includes the at least a part of the model description information of the AI model.

Optionally, the first identifier is associated with the AI model or is associated with at least a part of model description information of the AI model.

Optionally, the at least a part of the model description information of the AI model includes at least one of the following:
function information of the AI model;
a feature or feature group to which the AI model is applicable;
information about applicable scenarios of the AI model;
information about applicability configurations of the AI model;
input information of the AI model or a format of the input information;
output information of the AI model or a format of the output information; or
auxiliary information of the AI model, used for assisting the AI model to perform inference.

Optionally, the auxiliary information includes at least one of the following: the hardware configuration information; the antenna configuration information; the radio resource configuration information; or the wireless environment categorizing information.

Optionally, the information transmission apparatus 1000 further includes at least one of the following:
a second life cycle management module configured to perform life cycle management of the AI model based on the first identifier; or
a first determining module, configured to determine a second identifier for the AI model based on the first identifier and the at least a part of the model description information of the AI model, where the second identifier is used for identifying the AI model; and the second identifier is associated with the first identifier; and perform life cycle management of the AI model based on the second identifier.

Optionally, at least a part of bits, fields, or content in the second identifier includes the first identifier or a part of content of the first identifier, or is associated with the first identifier or the part of the content of the first identifier.

Optionally, the second identifier includes second information and third information. The second information is identifier information allocated by the network side device to the AI model when the network side device performs model identification.

The third information includes any one of the following: the first identifier; a part of content of the first identifier; the coding information of the first identifier; coding information of the part of the content of the first identifier; association information of the first identifier; or association information of the part of the content of the first identifier.

Optionally, the life cycle management of the AI model includes at least one of the following:
activation or deactivation of the AI model;
selection or switching of the AI model;
inference of the AI model;
performance monitoring or performance management of the AI model;
falling back to a non-AI model;
training or updating of the AI model;
registration of the AI model;
configuration of the AI model; or
identification of the AI model.

Optionally, the information transmission apparatus 1000 further includes:
a second sending module, configured to send the second identifier to the terminal.

Optionally, the information transmission apparatus 1000 further includes:
a second determining module, configured to determine a resource configuration used for data collection, where the resource configuration is associated with, indicates, or carries the first identifier; and
the resource configuration includes at least one of the following:
measurement configuration information;
report configuration information;
resource configuration information of a reference signal (RS) used for data collection;
resource set configuration information of an RS used for data collection;
master information block MIB information; or
system information block SIB information.

The information transmission apparatus in this embodiment of this application may be an electronic device, for example, an electronic device having an operating system, or may be a component, such as an integrated circuit or a chip, in an electronic device. The electronic device may be a terminal, or may be another device other than the terminal. For example, the terminal may include, but is not limited to, the types of the terminal 11 listed above, and the another device may be a server, a network attached storage (NAS), or the like. This is not specifically limited in this embodiment of this application.

The information transmission apparatus provided in this embodiment of this application can implement the processes implemented in the method embodiments of FIG. 4 to FIG. 8, and achieve the same technical effects. To avoid repetition, details are not described herein again.

As shown in FIG. 11, an embodiment of this application further provides a communication device 1100, including a processor 1101 and a memory 1102. The memory 1102 stores a program or instructions executable on the processor 1101. For example, when the communication device 1100 is a terminal, when the program or instructions are executed by the processor 1101, steps of the embodiments of the foregoing information transmission method are implemented, and the same technical effects can be achieved. When the communication device 1100 is a network side device, when the program or instructions are executed by the processor 1101, steps of the embodiments of the foregoing information transmission method are implemented, and the same technical effects can be achieved. To avoid repetition, details are not described herein again.

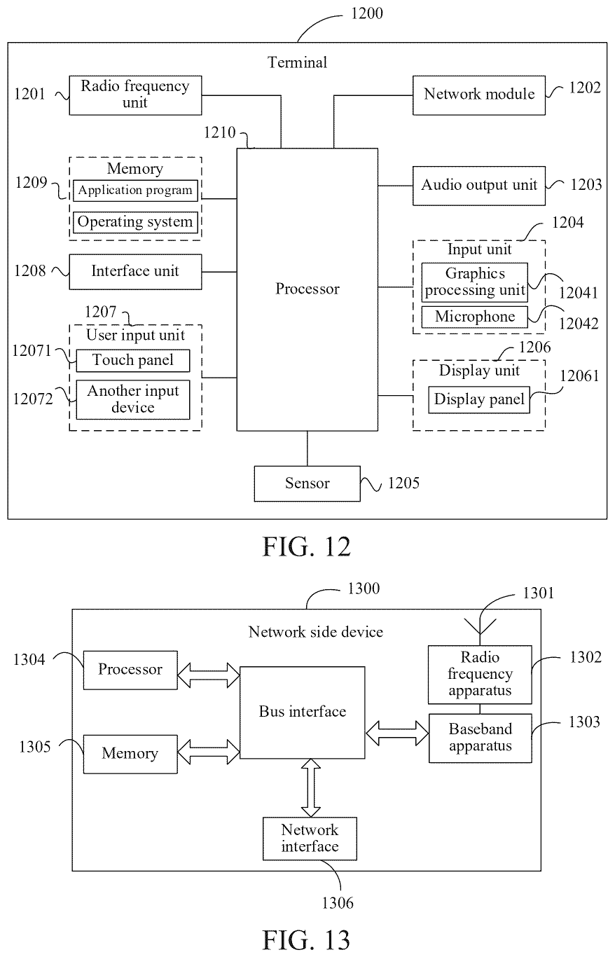

An embodiment of this application further provides a terminal, including a processor and a communication interface. The communication interface is coupled to the processor, and the processor is configured to run a program or instructions, to implement steps of the method embodiment shown in FIG. 4. This embodiment of the terminal corresponds to the foregoing method embodiment on a terminal side. Implementation processes and implementations of the foregoing method embodiment are applicable to this embodiment of the terminal, and the same technical effects can be achieved. Specifically, FIG. 12 is a schematic diagram of a hardware structure of a terminal according to an embodiment of this application.

The terminal 1200 includes, but is not limited to, at least a part of components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art may understand that the terminal 1200 may further include a power supply (such as a battery) for supplying power to the components. The power supply may be logically connected to the processor 1210 by a power management system, thereby implementing functions such as charging, discharging, and power consumption management by using the power management system. The structure of the terminal shown in FIG. 12 does not constitute a limitation on the terminal, and the terminal may include more or fewer components than shown, or some components may be combined, or a different component deployment may be used. Details are not described herein.

It should be understood that, in this embodiment of this application, the input unit 1204 may include a graphics processing unit (GPU) 12041 and a microphone 12042. The graphics processing unit 12041 processes image data of a static picture or a video that is obtained by an image capture device (for example, a camera) in a video capture mode or an image capture mode. The display unit 1206 may include a display panel 12061, and the display panel 12061 may be configured by using a liquid crystal display, an organic light-emitting diode, or the like. The user input unit 1207 includes a touch panel 12071 and at least one of another input device 12072. The touch panel 12071 is also referred to as a touchscreen. The touch panel 12071 may include two parts: a touch detection apparatus and a touch controller. The another input device 12072 may include, but is not limited to, a physical keyboard, a functional key (such as a volume control key or a switch key), a track ball, a mouse, and a joystick. Details are not described herein.

In this embodiment of this application, after receiving downlink data from a network side device, the radio frequency unit 1201 may transmit the downlink data to the processor 1210 for processing. In addition, the radio frequency unit 1201 may send uplink data to the network side device. Generally, the radio frequency unit 1201 includes, but is not limited to, an antenna, an amplifier, a transceiver, a coupler, a low noise amplifier, a duplexer, and the like.

The memory 1209 may be configured to store a software program or instructions and various data. The memory 1209 may mainly include a first storage area storing a program or instructions and a second storage area storing data. The first storage area may store an operating system, an application program or instructions required by at least one function (for example, a sound playback function and an image playback function), and the like. In addition, the memory 1209 may include a volatile memory or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), or a direct rambus random access memory (Direct Rambus RAM, DRRAM). The memory 1209 in this embodiment of this application includes, but is not limited to, these memories and any other suitable type of memory.

The processor 1210 may include one or more processing units. Optionally, the processor 1210 integrates an application processor and a modem processor. The application processor mainly processes operations related to the operating system, a user interface, an application program, and the like. The modem processor mainly processes a wireless communication signal, and is, for example, a baseband processor. It may be understood that the modem processor may alternatively not be integrated into the processor 1210.

The processor 1210 is configured to obtain an artificial intelligence (AI) model and a first identifier associated with the AI model, where the first identifier is associated with data collection or a dataset. The radio frequency unit 1201 is configured to send a target request to a network side device, where the target request includes the first identifier, and the target request is used for requesting to perform model identification of the AI model.

The terminal obtains the AI model and the first identifier associated with the AI model. Because the first identifier is associated with the data collection or the dataset, when the terminal requests the network side device to perform model identification of the AI model, the terminal needs to send only the first identifier to the network side device and does not need to report a large amount of model description information to the network side device, so that the network side device can perform model identification of the AI model based on the first identifier, thereby reducing signaling overheads of a communication system.

It may be understood that, for implementation processes of the implementations mentioned in this embodiment, refer to related descriptions of the information transmission method in the method embodiments, and the same or corresponding technical effects are achieved. To avoid repetition, details are not described herein again.

An embodiment of this application further provides a network side device, including a processor and a communication interface. The communication interface is coupled to the processor, and the processor is configured to run a program or instructions, to implement steps of the method embodiment shown in FIG. 5. This embodiment of the network side device corresponds to the foregoing method embodiment of the network side device. Implementation processes and implementations of the foregoing method embodiment are applicable to this embodiment of the network side device, and the same technical effects can be achieved.

Specifically, an embodiment of this application further provides a network side device. As shown in FIG. 13, the network side device 1300 includes an antenna 1301, a radio frequency apparatus 1302, a baseband apparatus 1303, a processor 1304, and a memory 1305. The antenna 1301 is connected to the radio frequency apparatus 1302. In an uplink direction, the radio frequency apparatus 1302 receives information by using the antenna 1301, and sends the received information to the baseband apparatus 1303 for processing. In a downlink direction, the baseband apparatus 1303 processes information to be sent and sends the information to the radio frequency apparatus 1302. The radio frequency apparatus 1302 processes the received information and sends the information by using the antenna 1301.

The method performed by the network side device in the foregoing embodiment may be implemented in the baseband apparatus 1303, and the baseband apparatus 1303 includes a baseband processor.

For example, the baseband apparatus 1303 may include at least one baseband board. A plurality of chips are disposed on the baseband board. As shown in FIG. 13, one of the chips is, for example, a baseband processor, and is connected to the memory 1305 through a bus interface, to invoke a program in the memory 1305, so as to perform the operations of the network side device shown in the foregoing method embodiments.

The network side device may further include a network interface 1306. The interface is, for example, a common public radio interface (CPRI).

Specifically, the network side device 1300 in this embodiment of this application further includes instructions or a program stored in the memory 1305 and executable on the processor 1304. The processor 1304 invokes the instructions or the program in the memory 1305, to perform the method performed by the modules shown in FIG. 13 and achieve the same technical effects. To avoid repetition, details are not described herein again.

An embodiment of this application further provides a readable storage medium. The readable storage medium stores a program or instructions. When the program or instructions are executed by a processor, processes of the embodiment of the foregoing information transmission method are implemented, and the same technical effects can be achieved. To avoid repetition, details are not described herein again.

The processor is the processor in the terminal in the foregoing embodiment. The readable storage medium includes a computer-readable storage medium, for example, a computer read-only memory (ROM), a random access memory (RAM), a magnetic disk, or an optical disk. In some examples, the readable storage medium may be a non-transitory readable storage medium.

An embodiment of this application further provides a chip. The chip includes a processor and a communication interface. The communication interface is coupled to the processor, and the processor is configured to run a program or instructions, to implement processes of the embodiment of the foregoing information transmission method, and achieve the same technical effects. To avoid repetition, details are not described herein again.

It should be understood that the chip mentioned in this embodiment of this application may also be referred to as a system on chip, a system chip, a chip system, a system-on-a-chip, or the like.

An embodiment of this application further provides a computer program/program product. The computer program/program product is stored in a storage medium, and the program/program product is executed by at least one processor, to implement processes of the embodiment of the foregoing information transmission method, and achieve the same technical effects. To avoid repetition, details are not described herein again.

An embodiment of this application further provides an information transmission system, including a terminal and a network side device. The terminal may be configured to perform steps of the foregoing information transmission method on the terminal side. The network side device may be configured to perform steps of the foregoing information transmission method on the network side device side.

It needs to be noted that, in this specification, the terms “include”, “comprise”, or any other variant thereof are intended to cover non-exclusive inclusion, so that a process, method, product, or apparatus that includes a series of elements includes not only the elements, but also another element not expressly listed, or an element inherent to such a process, method, product, or apparatus. An element defined by a statement “includes a . . . ” does not exclude, without more limitations, existence of another same element in a process, method, product, or apparatus that includes the element. In addition, it should be noted that the scope of the method and apparatus in the embodiments of this application is not limited to performing functions in an order shown or discussed, and may further include performing functions in a basically simultaneous manner or in a reverse order according to related functions. For example, the described method may be performed in an order different from the described order, and various steps may be added, omitted, or combined. In addition, features described with reference to some examples may be combined in some other examples.

According to the descriptions of the foregoing implementations, a person skilled in the art may clearly understand that the method in the foregoing embodiments may be implemented by using a computer software product and a necessary universal hardware platform, or may certainly be implemented by using hardware. The computer software product is stored in a storage medium (for example, a ROM, a RAM, a magnetic disk, or an optical disc), and includes several instructions, to enable a terminal or a network side device to perform the methods described in the embodiments of this application.

The foregoing describes the embodiments of this application with reference to the accompanying drawings. However, this application is not limited to the foregoing specific implementations. The foregoing specific implementations are merely examples, but are not limitative. Inspired by this application, a person of ordinary skill in the art may further make implementations in many forms without departing from the purposes of this application and the protection scope of the claims, and all the implementations shall fall within the protection of this application.

What is claimed is:

1. An information transmission method, comprising:
obtaining, by a terminal, an artificial intelligence (AI) model and a first identifier associated with the AI model, wherein the first identifier is associated with data collection or a dataset; and
sending, by the terminal, a target request to a network side device, wherein the target request comprises the first identifier, and the target request is used for requesting to perform model identification of the AI model.

2. The information transmission method according to claim 1, wherein the first identifier comprises first information or coding information of the first information, and the first information comprises at least one of the following:
information about a dataset or a dataset identifier (ID);
dataset categorizing information or a dataset categorizing ID;
information about additional conditions or an additional condition ID;
information about applicable conditions or an applicable condition ID;
information about applicable scenarios or an applicable scenario ID;
information about internal conditions or an internal condition ID;
cell information or a cell ID;
area information or an area ID;
scenario information or a scenario ID;
hardware configuration information or a hardware configuration ID;
antenna configuration information or an antenna configuration ID;
radio resource configuration information or a radio resource configuration ID;
wireless environment information or a wireless environment ID;
wireless environment categorizing information or a wireless environment categorizing ID;
radio access network (RAN) test configuration information or an RAN test configuration ID; or
wireless test configuration information or a wireless test configuration ID.

3. The information transmission method according to claim 1, wherein the target request further comprises at least a part of model description information of the AI model.

4. The information transmission method according to claim 3, wherein the at least a part of the model description information of the AI model comprises at least one of the following:
function information of the AI model;
a feature or feature group to which the AI model is applicable;
information about applicable scenarios of the AI model;
information about applicability configurations of the AI model;
input information of the AI model or a format of the input information;
output information of the AI model or a format of the output information; or
auxiliary information of the AI model, used for assisting the AI model to perform inference.

5. The information transmission method according to claim 4, wherein the auxiliary information comprises at least one of the following: hardware configuration information; antenna configuration information; radio resource configuration information; or wireless environment categorizing information.

6. The information transmission method according to claim 1, wherein the first identifier is associated with the AI model or is associated with at least a part of model description information of the AI model.

7. The information transmission method according to claim 1, wherein the method further comprises at least one of the following:
performing, by the terminal, life cycle management of the AI model based on the first identifier; or
receiving, by the terminal, a second identifier sent by the network side device, wherein the second identifier is used for identifying the AI model; and the second identifier is associated with the first identifier; and performing, by the terminal, the life cycle management of the AI model based on the second identifier.

8. The information transmission method according to claim 7, wherein the life cycle management of the AI model comprises at least one of the following:
activation or deactivation of the AI model;
selection or switching of the AI model;
inference of the AI model;
performance monitoring or performance management of the AI model;
falling back to a non-AI model;
training or updating of the AI model;
registration of the AI model;
configuration of the AI model; or
identification of the AI model.

9. An information transmission method, comprising:
receiving, by a network side device, a target request sent by a terminal, wherein the target request is used for requesting to perform model identification of an artificial intelligence (AI) model, the target request comprises a first identifier, and the first identifier is associated with data collection or a dataset; and
performing, by the network side device in response to the target request, the model identification of the AI model based on the first identifier.

10. The information transmission method according to claim 9, wherein the first identifier comprises first information or coding information of the first information, and the first information comprises at least one of the following:
information about a dataset or a dataset identifier (ID);
dataset categorizing information or a dataset categorizing ID;
information about additional conditions or an additional condition ID;
information about applicable conditions or an applicable condition ID;
information about applicable scenarios or an applicable scenario ID;
information about internal conditions or an internal condition ID;
cell information or a cell ID;
area information or an area ID;
scenario information or a scenario ID;
hardware configuration information or a hardware configuration ID;
antenna configuration information or an antenna configuration ID;
radio resource configuration information or a radio resource configuration ID;
wireless environment information or a wireless environment ID;
wireless environment categorizing information or a wireless environment categorizing ID;
radio access network (RAN) test configuration information or an RAN test configuration ID; or
wireless test configuration information or a wireless test configuration ID.

11. The information transmission method according to claim 9, wherein the target request further comprises at least a part of model description information of the AI model.

12. The information transmission method according to claim 11, wherein the at least a part of the model description information of the AI model comprises at least one of the following:
function information of the AI model;
a feature or feature group to which the AI model is applicable;
information about applicable scenarios of the AI model;
information about applicability configurations of the AI model;
input information of the AI model or a format of the input information;
output information of the AI model or a format of the output information; or
auxiliary information of the AI model, used for assisting the AI model to perform inference.

13. The information transmission method according to claim 12, wherein the auxiliary information comprises at least one of the following:
hardware configuration information;
antenna configuration information;
radio resource configuration information; or
wireless environment categorizing information.

14. The information transmission method according to claim 9, wherein the first identifier is associated with the AI model or is associated with at least a part of model description information of the AI model.

15. The information transmission method according to claim 11, wherein the method further comprises at least one of the following:
performing, by the network side device, life cycle management of the AI model based on the first identifier; or
determining, by the network side device, a second identifier for the AI model based on the first identifier and the at least a part of the model description information of the AI model, wherein the second identifier is used for identifying the AI model; and the second identifier is associated with the first identifier; and performing, by the network side device, the life cycle management of the AI model based on the second identifier.

16. The information transmission method according to claim 15, wherein at least a part of bits, fields, or content in the second identifier comprises the first identifier or a part of content of the first identifier, or is associated with the first identifier or the part of the content of the first identifier.

17. The information transmission method according to claim 15, wherein the method further comprises:
sending, by the network side device, the second identifier to the terminal.

18. The information transmission method according to claim 9, wherein the method further comprises:
determining, by the network side device, a resource configuration used for data collection, wherein the resource configuration is associated with, indicates, or carries the first identifier; and
the resource configuration comprises at least one of the following:
measurement configuration information;
report configuration information;
resource configuration information of a reference signal RS used for data collection;
resource set configuration information of an RS used for data collection;
master information block MIB information; or
system information block SIB information.

19. The network side device, comprising a processor and a memory, wherein the memory stores a program or instructions executable on the processor, and when the program or instructions are executed by the processor, steps of the information transmission method according to claim 9 are implemented.

20. A terminal, comprising a processor and a memory, wherein the memory stores a program or instructions executable on the processor, and when the program or instructions are executed by the processor, following steps are implemented:
obtaining an artificial intelligence (AI) model and a first identifier associated with the AI model, wherein the first identifier is associated with data collection or a dataset; and
sending a target request to a network side device, wherein the target request comprises the first identifier, and the target request is used for requesting to perform model identification of the AI model.
